(19) United States
(12) Patent Application Publication
(10) Pub. No.: US 2026/0362360 A1
(43) Pub. Date: Nov. 12, 2026

(54) USER EQUIPMENT POLICY MANAGEMENT FOR STAND-ALONE NON-PUBLIC NETWORKS

(71) Applicant: Lenovo (Singapore) Pte. Limited, Singapore (SG)

(72) Inventors: Roozbeh Atarius, La Jolla, CA (US); Genadi Velev, Darmstadt (DE); Apostolis Salkintzis, Glika Nera (GR)

(73) Assignee: Lenovo (Singapore) Pte. Limited, Singapore (SG)

(21) Appl. No.: 19/131,791

(22) PCT Filed: Jan. 16, 2023
(86) PCT No.: PCT/EP2023/050903

§ 371 Date: May 21, 2025

(30) Foreign Application Priority Data
Nov. 30, 2022 (GR) 20220100983

(51) Int. Cl. H04W 60/04; H04W 48/16; H04W 48/18; H04W 84/04

(52) U.S. Cl. CPC H04W 60/04; H04W 48/16; H04W 48/18; H04W 84/042

(57) ABSTRACT

There is provided a user equipment apparatus for wireless communication, comprising: a processor and a memory coupled with the processor. The processor is configured to cause the apparatus to receive, during a first registration of the user equipment apparatus to a wireless communication network, a first policy from a first network entity, the first policy comprising an access network discovery and selection policy ‘ANDSP’ wherein the ANDSP comprises an identity for a standalone non-public network ‘SNPN’ and an address of a non-3rd generation partnership project ‘3GPP’ access network for the SNPN. The processor is further configured to cause the apparatus to locate, using the address, the non-3GPP access network. The processor is further configured to cause the apparatus to perform, using the non-3GPP access network, a second registration of the user equipment apparatus to the SNPN, wherein the SNPN is identified by the identity of the SNPN. The processor is further configured to cause the apparatus to receive from a second network entity, a second policy for the SNPN.

### FIELD

The subject matter disclosed herein relates generally to the field of implementing user equipment policy management for stand-alone non-public networks. This document defines a user equipment apparatus, a network entity and a method in a user equipment apparatus, for wireless communication.

### BACKGROUND

The user equipment (UE) access network discovery and selection policy (ANDSP) is currently for public land mobile networks (PLMN). A UE may be registered to a PLMN or a stand-alone non-public network (SNPN) and may receive UE policies comprising ANDSP containing information for other PLMNs and SNPNs and how to access them.

The ANDSP is defined with the type ‘non-3GPP access network’ (N3AN) for untrusted non-3GPP access networks, and with the type ‘WLAN selection policy’ (WLANSP) for trusted non-3GPP access networks.

In the case of untrusted non-3GPP access networks, the content of the N3AN node selection information contains information regarding the PLMN identity as a Mobile Country Code (MCC) and Mobile Network Code (MNC) and the PLMN priority.

In the case of trusted non-3GPP access networks, the content of the WLANSP contains validity area, which is, if for 3GPP, the identity of the PLMN as MCC and MNC with tracking area information and cell identity.

Further specification for non-access-stratum (NAS) protocols for 5G systems and for user equipment policies for 5G systems are available at 3GPP technical specifications TS 24.501 and TS 24.526.

### SUMMARY

Currently, it is not clear how to distinguish the ANDSP for different SNPNs in the case where a UE receives ANDSP rules for more than one SNPN, assuming the SNPNs are associated to the same PLMN.

In addition, in the scenario where a UE registered in a PLMN receives ANDSP rules for an SNPN or vice versa (the UE is registered to an SNPN and receives ANDSP for a PLMN), it is not clear how to identify the domain for those ANDSP rules.

Moreover, if a UE can receive UE route selection policy (URSP) rules for other SNPNs or PLMNs while being registered to a PLMN or an SNPN, the UE cannot identify the source for the URSP rules.

Disclosed herein are procedures for user equipment policy management for stand-alone non-public networks. Said procedures may be implemented by a user equipment apparatus, a network entity and methods in a user equipment apparatus, for wireless communication.

There is provided a user equipment apparatus for wireless communication, comprising: a processor; and a memory coupled with the processor, the processor configured to cause the apparatus to: receive, during a first registration of the user equipment apparatus to a wireless communication network, a first policy from a first network entity, the first policy comprising an access network discovery and selection policy ‘ANDSP’ wherein the ANDSP comprises an identity for a standalone non-public network ‘SNPN’ and an address of a non-3rd generation partnership project ‘3GPP’ access network for the SNPN; locate, using the address, the non-3GPP access network; perform, using the non-3GPP access network, a second registration of the user equipment apparatus to the SNPN, wherein the SNPN is identified by the identity of the SNPN; and receive from a second network entity, a second policy for the SNPN.

There is further provided a network entity for wireless communication, comprising: a processor; and a memory coupled with the processor, the processor configured to cause the apparatus to: transmit, during a first registration of a user equipment apparatus to a wireless communication network, a first policy to the user equipment apparatus, the first policy comprising an ANDSP, wherein the ANDSP comprises an identity for a SNPN and an address for a non-3GPP access network for the SNPN.

There is further provided a method in a user equipment apparatus for wireless communication, comprising: receiving, during a first registration of a user equipment apparatus to a wireless communication network, a first policy from a first network entity, the first policy comprising an ANDSP, wherein the ANDSP comprises an identity for a SNPN and an address for a non-3GPP access network for the SNPN; locating, using the address, the non-3GPP access network; performing, using the non-3GPP access network, a second registration of the user equipment apparatus to the SNPN, wherein the SNPN is identified by the identity for the SNPN; and receiving, from a second network entity, a second policy for the SNPN.

There is further provided a method in a user equipment apparatus for wireless communication, comprising: receiving a first policy from a first network entity, the first policy comprising a user equipment policy section management sublist, the sublist comprising: a URSP comprising one or more traffic descriptors and one or more route selection descriptors and an identity for an SNPN or a PLMN the URSP can be applied to; and establishing, using the identity, a PDU session.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for implementing user equipment policy management for stand-alone non-public networks will now be described, by way of example only, with reference to the accompanying drawings, in which:

FIG. 1 illustrates an embodiment of a wireless communication system;

FIG. 2 illustrates an embodiment of a user equipment apparatus;

FIG. 3 illustrates an embodiment of a network node/entity;

FIG. 4 illustrates the structure of N3AN node selection information defined currently for ANDSP for untrusted non-3GPP access networks;

FIG. 5 illustrates the structure of the WLANSP rule defined currently for ANDSP for trusted non-3GPP access networks;

FIG. 6 illustrates an embodiment of a method in a user equipment apparatus for wireless communication;

FIG. 7 illustrates a further embodiment of a method in a user equipment apparatus for wireless communication;

FIG. 8 illustrates an embodiment of a method in a network entity for wireless communication;

FIG. 9 illustrates an embodiment of UE policy information for registration to an SNPN being received by a UE and a protocol data unit (PDU) session being established;

FIG. 10 illustrates an embodiment of a new N3AN node selection information entry;

FIG. 11 illustrates an embodiment of N3AN node selection information for an untrusted non-3GPP access network comprising the new N3AN node selection information entry of FIG. 10 and IP address for the untrusted non-3GPP access network;

FIG. 12 illustrates an embodiment of a new 5GPP location sub-entry;

FIG. 13 illustrates an embodiment of the WLANSP rule for a trusted non-3GPP access network comprising the new 5GPP location sub-entry of FIG. 12 and mapping information for the trusted non-3GPP access network; and

FIG. 14 illustrates an embodiment of URSP rules associated to an SNPN.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized.

The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.“ As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

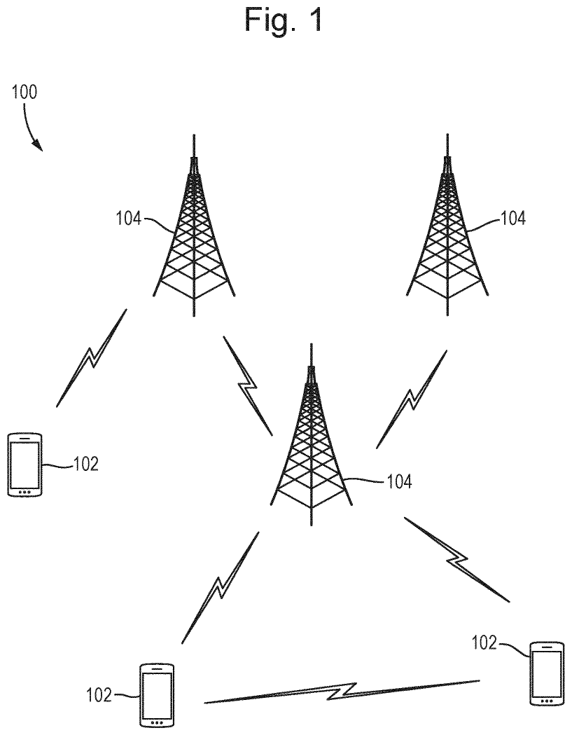

FIG. 1 depicts an embodiment of a wireless communication system 100 for user equipment policy management for stand-alone non-public networks. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA 2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

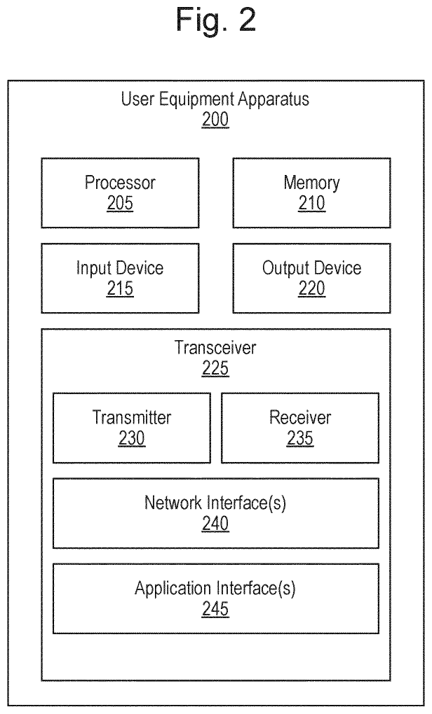

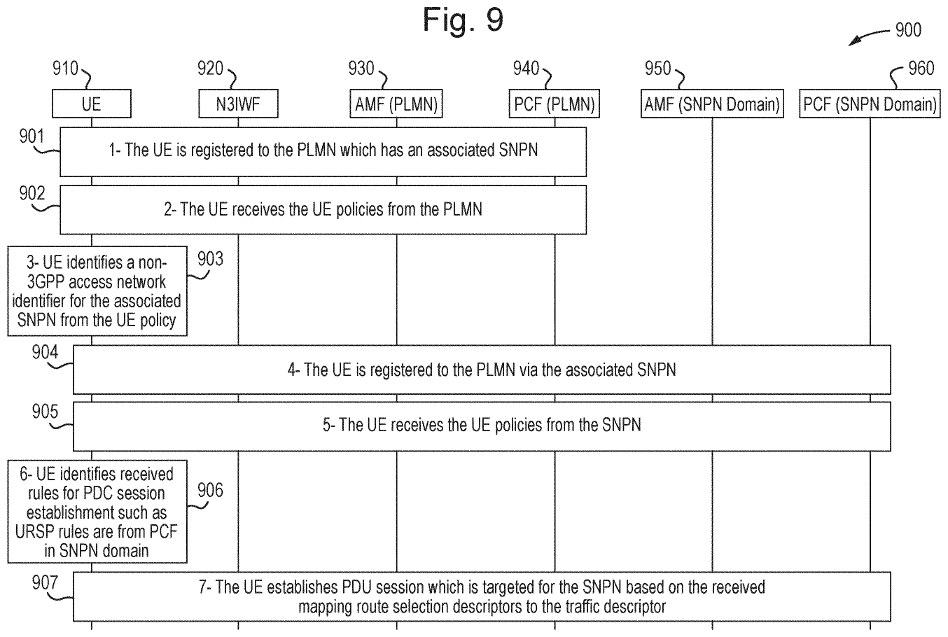

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a user equipment apparatus 910 of FIG. 9. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module. In another, non-limiting example, the user equipment apparatus 200 may comprise a universal subscriber identity module (USIM).

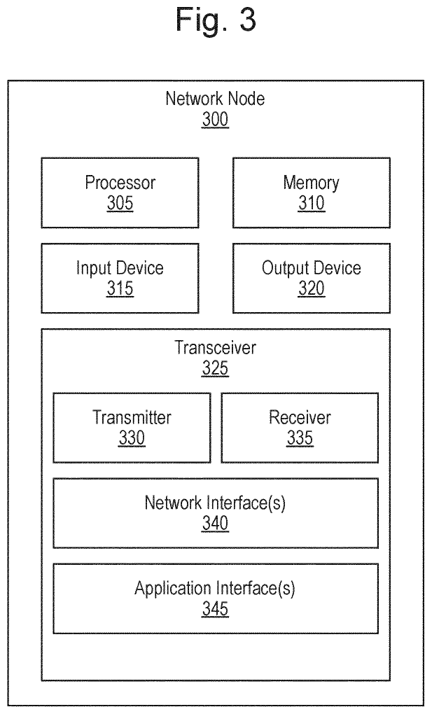

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise an N3IWF 920, an AMF 930 or 950, or a PCF 940 or 960, of FIG. 9. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

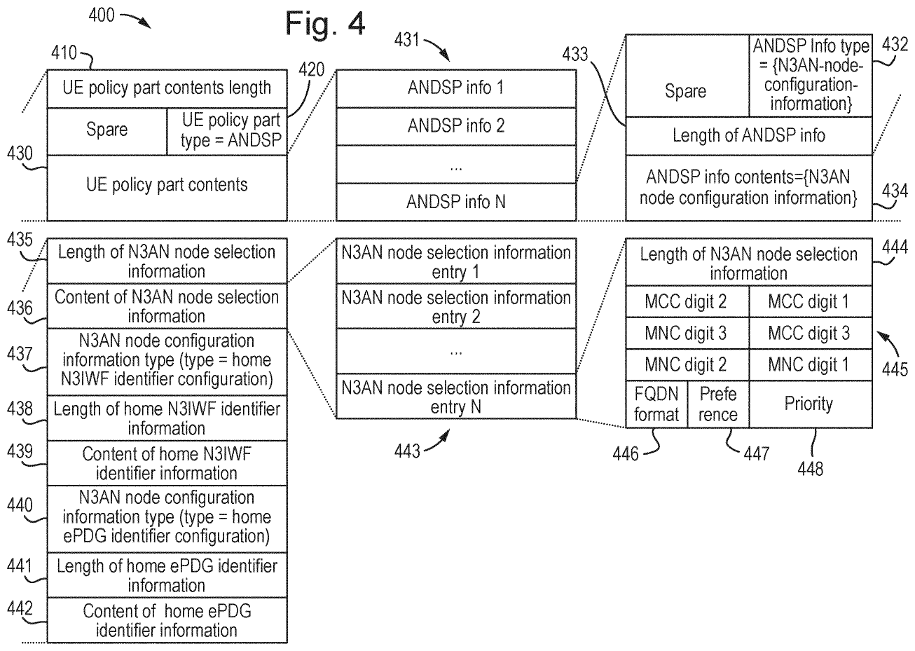

The UE policy access network discovery and selection policy (ANDSP) is currently for public land mobile networks (PLMN). FIG. 4 illustrates the structure of N3AN node selection information defined currently for ANDSP for untrusted non-3GPP access networks. The configuration information for the N3AN may be included as non-3GPP interworking function (N3IWF) or evolved packet data gateway (ePDG). In particular, FIG. 4 illustrates a UE policy part 400 of a UE policy comprising a UE policy part contents length 410, a UE policy part type 420 indicating the type as ANDSP and a UE policy part contents 430.

The UE policy part contents 430 is shown in expanded view as comprising a plurality of ANDSP information entries 431 spanning from entry 1-N.

An ANDSP information entry 431 is further expanded in the figure to show it comprising an ANDSP Information type 432 (shown in the figure as being the type equal to N3AN node configuration information), a length of ANDSP information 433 and an ANDSP information contents 434 (shown in the figure as being N3AN node configuration information).

The ANDSP information contents 434 if further expanded in the figure to show it comprising a length of N3AN node selection information 435, a content of N3AN node selection information 436, an N3AN node configuration information type 437 (for instance, the type is shown as home N3IWF identifier configuration), a length of home N3IWF identifier information 438, a content of home N3IWF identifier information 439, a further N3AN node configuration information type 440 (for instance, the type is shown as home ePDG identifier configuration), a length of home ePDG identifier information 441 and a content of home ePDG identifier information 442.

The content of N3AN node selection information 436 is further expanded to show it comprising a plurality of N3AN node selection information entries 443 from 1-N.

An example of a N3AN node selection information entry 443 is then further shown expanded in the figure to reveal it as comprising a length of N3AN node selection information entry 444, a plurality of mobile country code (MCC)/Mobile Network Code (MNC) digits 445, a fully qualified domain name (FQDN) format 446, a preference 447 and a priority 448.

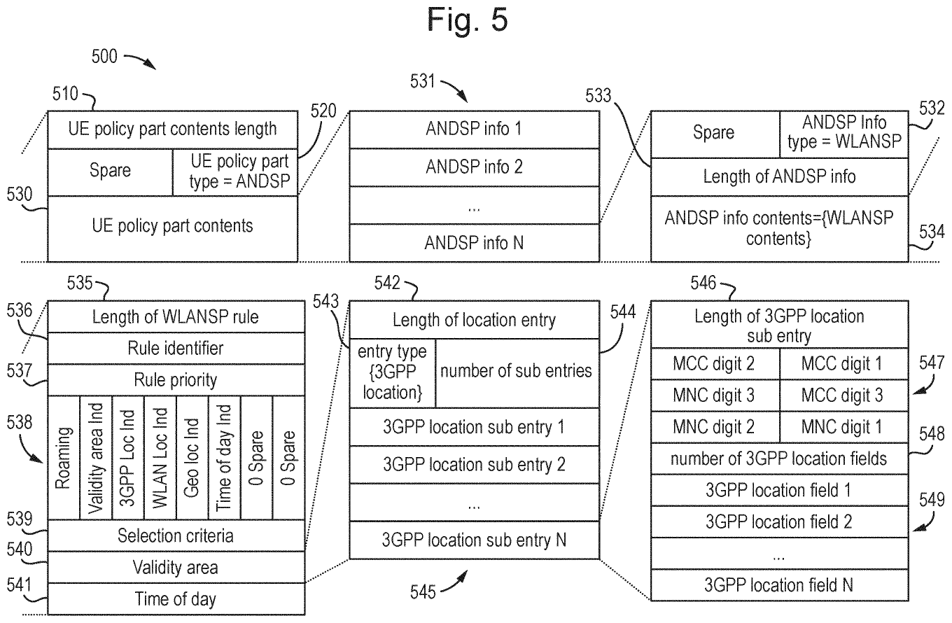

FIG. 5 illustrates the structure of the WLANSP rule defined currently for ANDSP for trusted non-3GPP access networks. The configuration information for the N3AN may be included as N3IWF or ePDG identifier.

In particular, FIG. 5 illustrates a UE policy part 500 comprising a UE policy part contents length 510, a UE policy part type 520 (shown as ANDSP in the figure) and a UE policy part contents 530.

The UE policy part contents 530 has been expanded to show it comprising a plurality of ANDSP information entries 531 spanning 1-N.

An example of an ANDSP information entry 531 has been further expanded in the figure to show it comprising an ANDSP Information type 532 (shown as WLANSP in the figure), a length of ANDSP information 533 and an ANDSP information contents 534 (shown in the figure as WLANSP contents).

An example of an ANDSP information contents 534 has also been further expanded in the figure to show it comprising a length of WLANSP rule 535, a rule identifier 536, a rule priority 537, a plurality of indications 538 (roaming, validity area, 3GPP location, WLAN location, geo location, time of day, etc.), a selection criteria 539, a validity area 540 and a time of day 541.

The validity area 540 is further expanded in the figure to show it comprising a length of location entry 542, an entry type 543 (shown as 3GPP location), a number of sub-entries 544 and a plurality of 3GPP location sub-entries 545 1-N.

An example of a 3GPP location sub entry 545 is further expanded in the figure to show it comprising a length of 3GPP location sub-entry 546, a plurality of MCC/MNC digits 547, a number of 3GPP location fields 548 and a plurality of 3GPP location fields 549 1-N. The 3GPP location fields 549 contain information for tracking area information and also cell identity for NR or E-UTRA. The configuration information for the trusted non-3GPP access network is included within the selection criteria of the WLANSP rule.

A UE may be registered to a PLMN or an SNPN and may receive UE policies comprising ANDSP containing information for other PLMNs and SNPNs and how to access them. However, it is currently unclear how to distinguish the ANDSP for different SNPNs in case the UE receives ANDSP rules for more than one SNPN, assuming the SNPNs are associated to the same PLMN. Further, where a UE is registered in a PLMN and receives ANDSP rules for a SNPN (or vice versa) it is not clear how to identify the domain for said ANDSP rules. Even further, if the UE can receive URSP rules for other SNPNs or PLMNs while being registered to a PLMN or an SNPN, the UE cannot currently identify the source for the URSP rules.

The present application presents a solution to these problems.

There is provided a user equipment apparatus for wireless communication. The user equipment apparatus comprising a processor and a memory coupled with the processor. The processor is configured to cause the apparatus to receive, during a first registration of the user equipment apparatus to a wireless communication network, a first policy from a first network entity, the first policy comprising an access network discovery and selection policy ‘ANDSP’ wherein the ANDSP comprises an identity for a standalone non-public network ‘SNPN’ and an address of a non-3rd generation partnership project ‘3GPP’ access network for the SNPN. The processor being further configured to cause the apparatus to locate, using the address, the non-3GPP access network. The processor being further configured to cause the apparatus to perform, using the non-3GPP access network, a second registration of the user equipment apparatus to the SNPN, wherein the SNPN is identified by the identity of the SNPN.

The processor being further configured to cause the apparatus to receive from a second network entity, a second policy for the SNPN.

In some embodiments, the second policy comprises the identity of the SNPN, such that the user equipment apparatus can identify the SNPN as a source of the second policy.

In some embodiments, the first registration is a registration to a public land mobile network ‘PLMN’ and the second registration is a registration to the SNPN.

In some embodiments, the first network entity is a policy control function ‘PCF’ of the PLMN and the second network entity is a PCF of the SNPN.

In some embodiments, the ANDSP comprises one or more policies for a trusted non-3GPP access network and/or for an untrusted non-3GPP access network.

In some embodiments, the ANDSP comprises WLANSP rules, the WLANSP rules comprising the identity for the SNPN and address for the trusted non-3GPP access network.

In some embodiments, the untrusted non-3GPP access network is selected from the list consisting of: a non-3GPP interworking function, N3IWF; and an evolved packet data gateway, ePDG.

In some embodiments, the ANDSP comprises node configuration information comprising the identity for the SNPN and address of the untrusted non-3GPP access network.

In some embodiments, the ANDSP further comprises an assignment mode parameter associated with the SNPN.

In some embodiments, the second policy comprises the identity of the SNPN and a UE route selection policy ‘URSP’ for protocol data unit ‘PDU’ session establishment.

In some embodiments, the URSP comprises one or more traffic descriptors and one or more route selection descriptors.

In some embodiments, the processor is further configured to cause the user equipment apparatus to establish a PDU session using the identity of the SNPN and the URSP.

In some embodiments, the wireless communication network is a 3GPP network.

According to a further aspect, there is provided a network entity for wireless communication, comprising a processor; and a memory coupled with the processor. The processor is configured to cause the apparatus to transmit, during a first registration of a user equipment apparatus to a wireless communication network, a first policy to the user equipment apparatus, the first policy comprising an ANDSP, wherein the ANDSP comprises an identity for a SNPN and an address for a non-3GPP access network for the SNPN.

In some embodiments, the network entity is a PCF of a PLMN.

In some embodiments, the ANDSP comprises one or more policies for a trusted non-3GPP access network and/or one or more policies for an untrusted non-3GPP access network.

In some embodiments, the ANDSP comprises WLANSP rules, the WLANSP rules comprising the identity for the SNPN and address for the trusted non-3GPP access network.

In some embodiments, the untrusted non-3GPP access network is selected from the list consisting of: a non-3GPP interworking function, N3IWF; and an evolved packet data gateway, ePDG.

In some embodiments, the ANDSP comprises node configuration information comprising the identity for the SNPN and address for the untrusted non-3GPP access network.

In some embodiments, the ANDSP further comprises an assignment mode parameter associated with the SNPN.

In some embodiments, the wireless communication network is a 3GPP network.

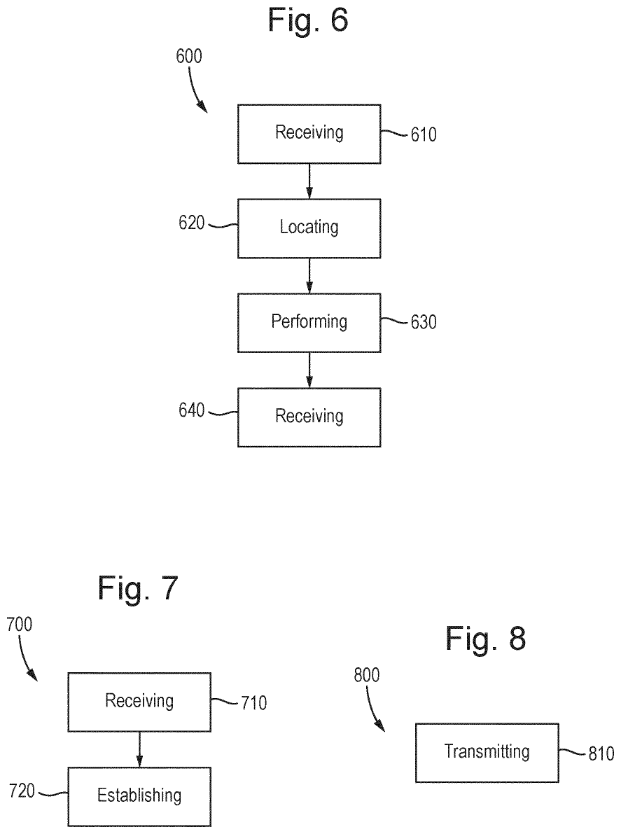

FIG. 6 illustrates an embodiment of a method 600 in a user equipment apparatus for wireless communication. A first step 610 comprises receiving, during a first registration of a user equipment apparatus to a wireless communication network, a first policy from a first network entity, the first policy comprising an ANDSP, wherein the ANDSP comprises an identity for a SNPN and an address for a non-3GPP access network for the SNPN. A further step 620 comprises locating, using the address, the non-3GPP access network. A further step 630 comprises performing, using the non-3GPP access network, a second registration of the user equipment apparatus to the SNPN, wherein the SNPN is identified by the identity for the SNPN. A further step 640 comprises receiving, from a second network entity, a second policy for the SNPN.

In some embodiments, the second policy comprises the identity for the SNPN, such that the user equipment can identify the SNPN as a source of the second policy.

In some embodiments, the first registration is a registration to a PLMN and the second registration is a registration to the SNPN.

In some embodiments, the first network entity is a PCF of the PLMN and the second network entity is a PCF of the SNPN.

In some embodiments, the ANDSP comprises one or more policies for a trusted non-3GPP access network and/or one or more policies for an untrusted non-3GPP access network.

In some embodiments, the ANDSP comprises WLANSP rules, the WLANSP rules comprising the identity for the SNPN and address for the trusted non-3GPP access network.

In some embodiments, the untrusted non-3GPP access network is selected from the list consisting of: a non-3GPP interworking function, N3IWF; and an evolved packet data gateway, ePDG.

In some embodiments, the ANDSP comprises node configuration information comprising the identity for the SNPN and address for the untrusted non-3GPP access network.

In some embodiments, the ANDSP further comprises an assignment mode parameter associated with the SNPN.

In some embodiments, the second policy comprises the identity of the SNPN and a URSP for PDU session establishment.

In some embodiments, the URSP comprises one or more traffic descriptors and one or more route selection descriptors.

In some embodiments, the method further comprises the step of establishing a PDU session using the identity of the SNPN and the URSP.

In some embodiments, the wireless communication network is a 3GPP network.

FIG. 7 illustrates a further embodiment of a method 700 in a user equipment apparatus for wireless communication. A first step 710 comprises receiving a first policy from a first network entity, the first policy comprising: a user equipment policy section management sublist, the sublist comprising a URSP comprising one or more traffic descriptors and one or more route selection descriptors; and an identity for an SNPN or a PLMN the URSP can be applied to. A further step 720 comprises establishing, using the identity, a PDU session.

In some embodiments, establishing a PDU session comprises establishing the PDU session when the user equipment apparatus is registered to the SNPN or PLMN.

FIG. 8 illustrates an embodiment of a method 800 in a network entity for wireless communication. A first step 810 comprises transmitting, during a first registration of a user equipment apparatus to a wireless communication network, a first policy to the user equipment apparatus, the first policy comprising an ANDSP, wherein the ANDSP comprises an identity for a SNPN and an address for a non-3GPP access network for the SNPN.

In some embodiments, the network entity is a PCF of a PLMN.

In some embodiments, the ANDSP comprises one or more policies for a trusted non-3GPP access network and/or one or more policies for an untrusted non-3GPP access network.

In certain embodiments, the methods 600, 700 or 800, may be performed by a processor executing program code, for example, a microcontroller, a microprocessor, a CPU, a GPU, an auxiliary processing unit, a FPGA, or the like.

FIG. 9 illustrates an embodiment 900 of UE policy information for registration to an SNPN being received by a UE and a protocol data unit (PDU) session being established. The embodiment 900 shows a UE 910, an N3IWF 920, an AMF (PLMN) 930, a PCF (PLMN) 940, an AMF (SNPN Domain) 950, a PCF (SNPN Domain) 960.

In a first step 901, the UE 910 is registered to the PLMN and performed the UE-initiated UE state indication procedure as described in 3GPP TS 24.501 to deliver one or more UPSIs of the UE policy sections; the UE's support for ANDSP; and the UE's supporting one or more OS Ids to the PCF 940. The PLMN has an associated SNPN.

In a further step 902, the UE policy for the PLMN is transmitted towards the UE 910 by the PCF 940.

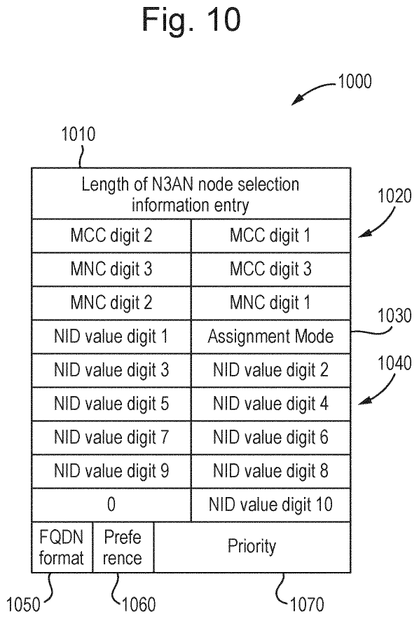

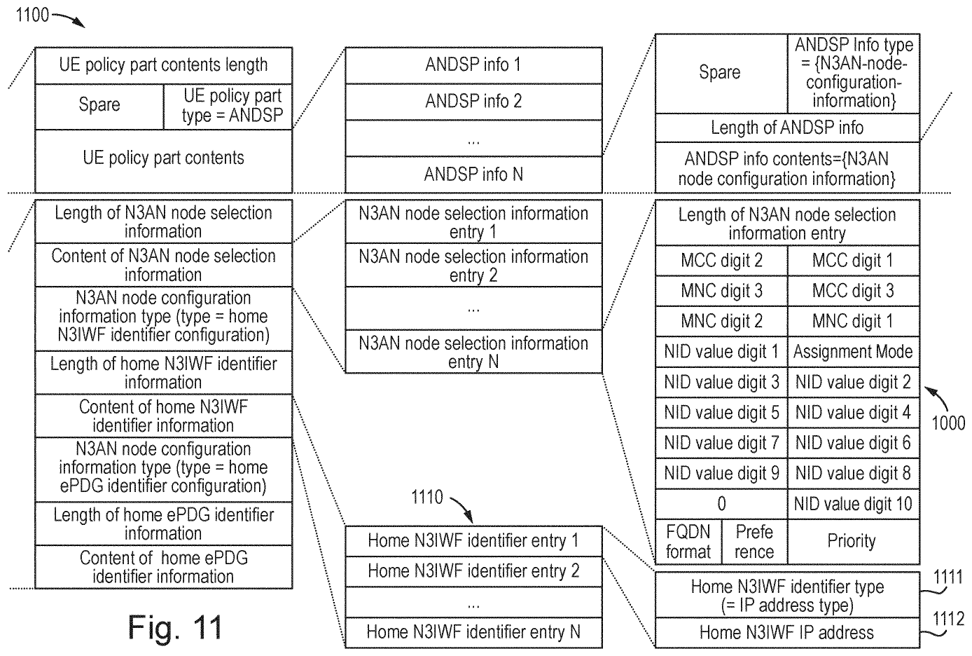

The UE policy comprises ANDSP comprising information for an untrusted non-3GPP access network such as an N3IWF or an ePDG to reach an SNPN associated to the PLMN by defining the N3AN node configuration information with the N3AN node selection information entry, differing from the currently defined configuration information in FIG. 4, as shown in FIGS. 10 and 11, to provide information about the SNPN. Furthermore, the mapping information for the non-3GPP access network such as N3IWF or ePDG for the SNPN identified in the new N3AN node selection information entry may be comprised in the N3AN node configuration information, differing from the currently defined configuration information in FIG. 4, as shown in FIG. 11.

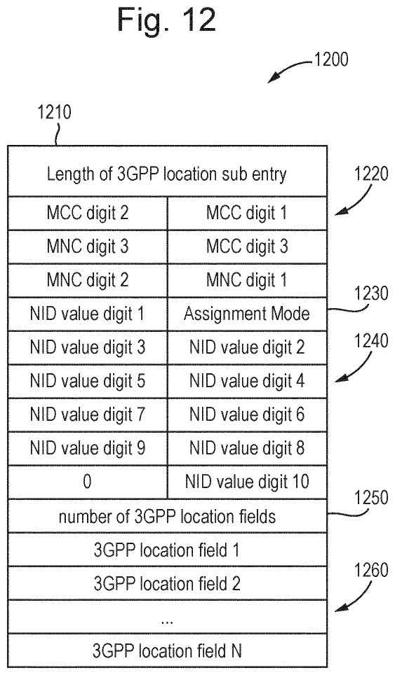

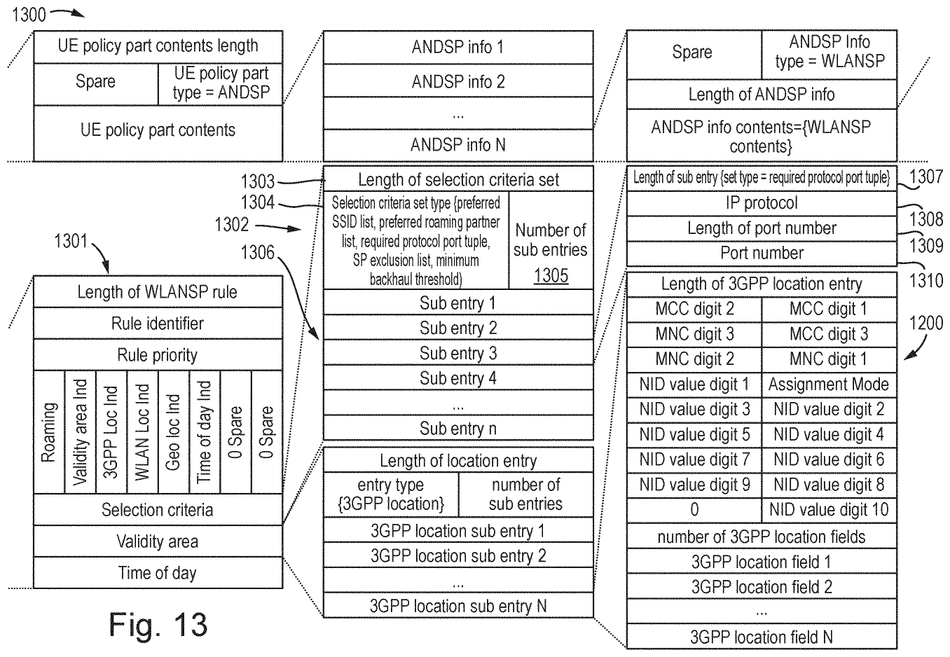

The UE policy further comprises ANDSP comprising information for a trusted non-3GPP access network such as a TNAN to reach an SNPN associated to the PLMN by defining the WLANSP rules with the 3GPP location sub entry, differing from the currently defined WLANSP rules of FIG. 5 as shown in FIGS. 12 and 13. Furthermore, the mapping information for the non-3GPP access network such as TNAN for the SNPN identified in the new 3GPP location sub entry may be comprised in the selection criteria of the WLANSP rule, as shown in FIG. 13 which is a modification of FIG. 5 with the new 5GPP location sub entry and the information for the trusted non-3GPP access network.

In a further step 903, the UE 910 identifies a non-3GPP access network identifier for the associated SNPN from the UE policy received in step 902.

In a further step 904, the UE 910 may be deregistered from the PLMN and is registering to the SNPN via either of a untrusted non-3GPP access network or trusted non-3GPP access network by the UE policy ANDSP received from the PCF 940 while being registered to the PLMN in step 902.

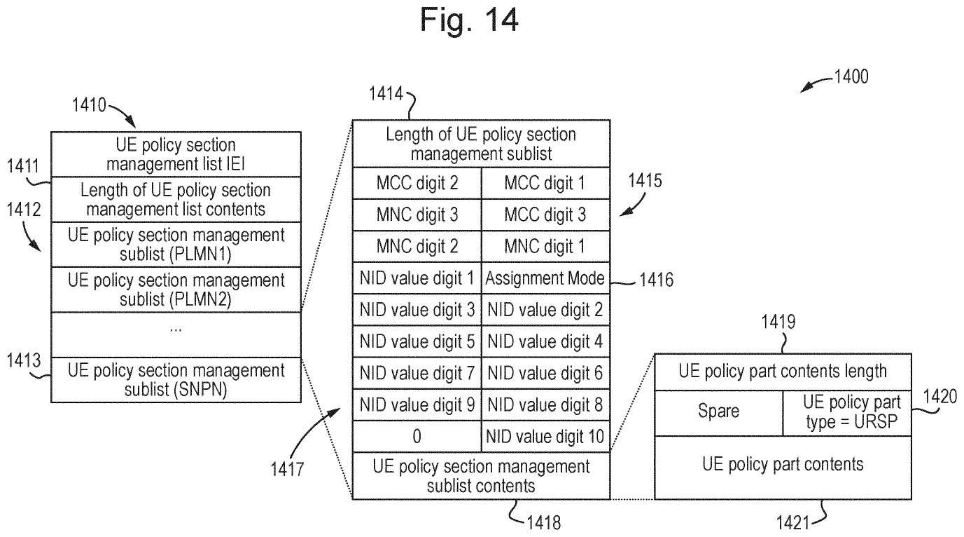

In a further step 905, the UE 910 may receive a set of UE policies from the PCF 960 from the SNPN domain. The set of the policies may include the URSP rules which are associated to the SNPN, for PDU session establishment. The structure of the URSP rules associated to an SNPN may be in accordance with FIG. 14 which shows a UE policy section management sublist comprising the SNPN identity, such that the UE 910 can identify that the URSP rules are for the SNPN identified in the UE policy section management sublist.

In a further step 906, the UE 910 identifies received rules for PDU session establishment such as the URSP rules from PCF 960 in the SNPN domain. In order for the UE 910 to establish a PDU session by using URSP from the SNPN with the PDU session targeting for the SNPN, the UE 910 identifies the identity for the SNPN in the UE policy section management sublist (as shown in FIG. 14). The UE 910 uses the routing and traffic descriptors from the received URSP rules to establish the PDU session. URSP rules are defined in 3GPP TS 24.526.

In a further step 907, the UE 910 has established the PDU session which is targeted for the SNPN based on the received mapping route selection descriptors to the traffic descriptor.

FIG. 10 illustrates an embodiment of a new N3AN node selection information entry 1000 differing from the N3AN node selection information entry shown in FIG. 4. The entry 1000 comprises a length of N3AN node selection information entry 1010, a plurality of MCC/MNC digits 1020, an assignment mode 1030, a plurality of NID digits 1040, a FQDN format 1050, a preference 1060 and a priority 1070.

The NID digits 1040 are for network identifier and comprise eleven hexadecimal digits.

The assignment mode 1030 comprises a value of zero, if the NID 1040 is globally unique, independent from PLMN identity which is defined as the values for MCC and MNC; or the assignment mode 1030 comprises a value of one, if the combination of the NID 1040 and PLMN identity is globally unique.

FIG. 11 illustrates an embodiment 1100 of N3AN node selection information for an untrusted non-3GPP access network comprising the new N3AN node selection information entry 1000 of FIG. 10 and IP address for the untrusted non-3GPP access network.

Comparing to FIG. 4, the currently defined ANDSP specified in FIG. 4 has been augmented in FIG. 11 through the inclusion of the new structure for N3AN node selection information entries 1000. The currently defined ANDSP specified in FIG. 4 has been further augmented in FIG. 11 with the inclusion of a plurality of Home N3IWF identifiers 1110, each identifier 1110 being expanded in the figure to show it comprising a Home N3IWF identifier type (i.e. IP address type) 1111 and a Home N3IWF IP address 1112.

The node selection information may include more than one domain identity which may be one or more identities of SNPNs or PLMNs within the N3AN node selection information entries, wherein the untrusted non-3GPP access networks are also defined for those domains.

FIG. 12 illustrates an embodiment 1200 of a new 5GPP location sub-entry, differing from the sub-entry shown in FIG. 5. The new sub-entry 1200 comprises a length of 3GPP location sub-entry 1210, a plurality of MCC/MNC digits 1220, an assignment mode 1230, a plurality of NID digits 1240, a number of 3GPP location fields 1250, and a plurality of 3GPP location fields 1-N 1260.

The assignment mode 1230 is defined as per FIG. 10. The NID digits 1240 are defined as per FIG. 10. The assignment mode 1230 and NID 1240 provide distinction over the sub-entry shown in FIG. 5.

FIG. 13 illustrates an embodiment 1300 of the WLANSP rule for a trusted non-3GPP access network comprising the new 5GPP location sub-entry 1200 of FIG. 12 and mapping information for a trusted non-3GPP access network.

Comparing with FIG. 5, the currently defined WLANSP rule in FIG. 5 has been augmented in FIG. 13 by incorporating the new structure for 5GPP location sub-entries 1200 of FIG. 12. The embodiment 1300 of FIG. 13 further includes in the ANDSP information content 1301 (shown as WLANSP contents) a selection criteria 1302 also having a new structure. The selection criteria 1302 comprising a length of selection criteria 1303, a selection criteria set type 1304 (preferred SSID list, preferred roaming partner list, required protocol port tuple, SP exclusion list, minimum backhaul threshold), a number of sub entries 1305, and a plurality of sub-entries 1-N 1306.

A sub-entry 1306 has been expanded in the figure to show it comprising a length of sub entry (set type equals required protocol port tuple) 1307, an IP protocol 1308, a length of port number 1309, and a port number 1310.

The 3GPP location entry may include more than one domain identity which may be one or more 3GPP location sub entries with identities of SNPNs or PLMNs, wherein the trusted non-3GPP access networks are also defined for those domains in assigned sub entries of the selection criteria.

FIG. 14 illustrates an embodiment 1400 of URSP rules associated to an SNPN. In particular, FIG. 14 illustrates a UE policy section management list IEI 1410 comprising a length of UE policy section management list contents 1411, a plurality of UE policy section management sublists 1412 (PLMN1, PLMN2, etc) and a new UE policy section management sublist (SNPN) 1413.

The new UE policy section management sublist 1413 is expanded in the figure to show it comprising a length of UE policy section management sublist 1414, a plurality of MCC/MNC digits 1415, an assignment mode 1416, a plurality of NID value digits 1417 and a UE policy section management sublist contents 1418.

The UE policy section management sublist contents 1418 is expanded in the figure to show it comprising a UE policy part contents length 1419, a UE policy part type 1420 (i.e. URSP) and a UE policy part contents 1421.

The assignment mode 1416 and NID 1417 are those defined for FIG. 10. If a UE while registered to a PLMN can receive URSP rules for PDU session establishment while being registered to a SNPN, from a PCF in the PLMN domain, the structure of the URSP rules will be in accordance with FIG. 14 to identify that the URSP rules are for the SNPN which is identified with that specific NID 1417.

The apparatuses and methods described herein allow a UE to identify the identity of an SNPN when receiving ANDSP from a PCF in the PLMN domain. In addition, the apparatuses and methods described herein allow a UE to identify that received URSP rules are for an SNPN or for a PLMN.

The disclosure described herein relates to a method comprising: receiving by a device from a first network entity a first policy comprising an access network discovery and selection policy (ANDSP) during a first registration, wherein, the ANDSP comprises: an identity for a standalone non-public network (SNPN); and an address for a non-3GPP access network; using the address of the non-3GPP access network by the device to locate the non-3GPP access network to perform a second registration to the SNPN, wherein the SNPN is identified by the identity; and receiving by the device a second policy from a second network entity, wherein the second policy is valid for the SNPN.

In some embodiments, the second policy comprises the identity of the SNPN so that the device can identify the SNPN as a source of the second policy.

In some embodiments the first network entity is a policy control function (PCF) for a PLMN; and the second network entity is a PCF for SNPN, wherein the SNPN is associated to the PLMN.

In some embodiments, the first registration is to the PLMN; and the second registration is to the SNPN.

In some embodiments, the ANDSP comprises one or more policies for trusted non-3GPP access network.

In some embodiments, the ANDSP comprises one or more policies for untrusted non-3GPP access network.

The disclosure herein further relates to a method comprising: receiving by a device from a first network entity during a first registration, a first policy comprising a UE policy section management sublist comprising: an identity; and a UE route selection policy (URSP), wherein, the URSP comprises: one or more traffic descriptors; and one or more route selection descriptors; wherein the identity identifies an SNPN or a PLMN the URSP can be applied; and using the identity and the URSP by the device to establish a PDU session.

In some embodiments, the PDU session is established when the device is registered to the SNPN or the PLMN.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 5GCN, 5G Core Network; 5GS, 5G System; AMF, Access and Mobility Management Function; ANDSP, Access Network Discovery and Selection Policy; DNN, Data Network Name; DNS, Domain Name System; ePDG, evolved Packet Data Gateway; FQDN, Fully Qualified Domain Name; IP, Internet Protocol; LCS, Location Services; N3AN, Non-3GPP Access Network; N3IWF, Non-3GPP InterWorking Function; NEF, Network Exposure Function; NID, Network Identifier; OS Id, Operating System Identity; OS App Id, Operating System Application Identity; PCF, Policy Control Function; PLMN, Public Land Mobile Network; PLMN ID, Public Land Mobile Network identity; MCC, Mobile Country Code; MNC, Mobile Network Code; NID, Network Identifier; SMF, Session and Mobility Management Function; SNPN, Standalone Non-Public Network; S-NSSAI, Single Network Slice Selection Assistance Information; SSC, Session and Service Continuity; UDM, Unified Data Management; UDR, Unified Data Repository; UPSI, UE Policy Section Identifier; URSP, UE Route Selection Policy; and WLANSP, WLAN Selection Policy.

1. A user equipment (UE) for wireless communication, comprising:
at least one memory; and
at least one processor coupled with the at least one memory and configured to cause the UE to:
receive, during a first registration of the UE to a wireless communication network, a first policy from a first network entity, wherein the first policy comprises an access network discovery and selection policy (ANDSP), and wherein the ANDSP comprises an identity of a standalone non-public network (SNPN) and an address of a non-3rd generation partnership project (non-3GPP) access network for the SNPN;
locate, using the address, the non-3GPP access network;
perform, using the non-3GPP access network, a second registration of the UE to the SNPN, and
receive from a second network entity, a second policy for the SNPN.

2. The UE of claim 1, wherein the second policy comprises the identity of the SNPN.

3. The UE of claim 1, wherein the first registration is a registration to a public land mobile network (PLMN) and wherein the second registration is a registration to the SNPN.

4. The UE of claim 3, wherein the first network entity is a policy control function (PCF) of the PLMN and wherein the second network entity is a PCF of the SNPN.

5. The UE of claim 1, wherein the ANDSP further comprises one or more policies for a trusted non-3GPP access network and/or for an untrusted non-3GPP access network.

6. The UE of claim 1, wherein the ANDSP further comprises an assignment mode parameter associated with the SNPN.

7. The UE of claim 1, wherein the second policy comprises the identity of the SNPN and a UE route selection policy (URSP) for protocol data unit (PDU) session establishment.

8. The UE of claim 7, wherein the URSP comprises one or more traffic descriptors and one or more route selection descriptors.

9. The UE of claim 7, wherein the at least one processor is further configured to cause the UE to establish a PDU session using the identity of the SNPN and the URSP.

10. The UE of claim 1, wherein the wireless communication network is a 3rd generation partnership project (3GPP) network.

11. A network entity for wireless communication, comprising:
at least one memory; and
at least one processor coupled with the at least one memory and configured to cause the network entity to:
transmit, during a first registration of a user equipment (UE) to a wireless communication network, a first policy to the UE, wherein the first policy comprises an access network discovery and selection policy (ANDSP), and wherein the ANDSP comprises an identity for a standalone non-public network (SNPN) and an address for a non-3rd generation partnership project (non-3GPP) access network for the SNPN.

12. The network entity of claim 11, wherein the network entity is a policy control function (PCF) of a public land mobile network (PLMN).

13. The network entity of claim 11, wherein the ANDSP further comprises one or more policies for a trusted non-3GPP access network and/or one or more policies for an untrusted non-3GPP access network.

14. The network entity of claim 11, wherein the ANDSP further comprises an assignment mode parameter associated with the SNPN.

15. The network entity of claim 11, wherein the wireless communication network is a 3rd generation partnership project (3GPP) network.

16. A method performed by a user equipment (UE), comprising:
receiving, during a first registration of the UE to a wireless communication network, a first policy from a first network entity, wherein the first policy comprises an access network discovery and selection policy (ANDSP), wherein the ANDSP comprises an identity for a standalone non-public network (SNPN) and an address for a non-3rd generation partnership project (non-3GPP) access network for the SNPN;
locating, using the address, the non-3GPP access network;
performing, using the non-3GPP access network, a second registration of the UE to the SNPN, and
receiving, from a second network entity, a second policy for the SNPN.

17. (canceled)

18. The method of claim 16, wherein the first registration is a registration to a public land mobile network (PLMN) and the second registration is a registration to the SNPN.

19. The method of claim 18, wherein the first network entity is a policy control function (PCF) of the PLMN and the second network entity is a PCF of the SNPN.

20. (canceled)

21. (canceled)

22. The method of claim 19, wherein the second policy comprises the identity of the SNPN and a UE route selection policy (URSP) for protocol data unit (PDU) session establishment.

23-27. (canceled)

28. A method performed by a network entity, the method comprising:
transmitting, during a first registration of a user equipment (UE) to a wireless communication network, a first policy to the UE, wherein the first policy comprises an access network discovery and selection policy (ANDSP), and wherein the ANDSP comprises an identity for a standalone non-public network (SNPN) and an address for a non-3rd generation partnership project (non-3GPP) access network for the SNPN.
